(19) United States
(12) Patent Application Publication
(10) Pub. No.: US 2023/0364839 A1
(43) Pub. Date: Nov. 16, 2023

(54) ROTARY INJECTION MOLD AND PRODUCTION PROCESS FOR PRODUCING SWIRL INJECTION MOLDED PART

(71) Applicant: NINGBO MR.BEAR TECHNOLOGY CO., LTD, Yuyao City (CN)

(72) Inventor: Zhenhui Lu, Yuyao City (CN)

(21) Appl. No.: 18/359,634

(22) Filed: Jul. 26, 2023

(30) Foreign Application Priority Data
Jun. 29, 2023 (CN) 2023107888164

(51) Int. Cl. B29C 45/26

(52) U.S. Cl. CPC B29C 45/2681; B29K 2995/0021

(57) ABSTRACT

The disclosure provides a rotary injection mold for producing a swirl injection molded part comprising: a first mold; a second mold; a first mold core rotatably mounted in the first mold; a second mold core rotatably mounted in the second mold; and a driving mechanism; and an injection molding hole is provided on the first mold core and/or the second mold core for injecting an injection molding liquid into the injection molding cavity. With the above solution, a rotary injection mold is provided which produces an injection molded part with a swirl pattern.

### TECHNICAL FIELD

The present invention pertains to the field of molds, and specifically pertains to a rotary injection mold and production process for producing a swirl injection molded part.

### BACKGROUND

Injection molded parts are products formed by hot melt injection molding through a mold, for example, a flying disc is inject molded with a mold.

Specifically, an injection mold comprises an upper mold and a lower mold, the upper mold and the lower mold are clamped to form an injection molding cavity adapted to the shape and size of the injection molded part, and an upper end of the upper mold is generally provided with an injection molding channel so as to fill an injection molding liquid into the injection molding cavity through the injection molding channel and cool the same into the injection molded part, and finally the injection molding cavity is opened by means of demolding from top to bottom and the injection molded part is removed.

In addition, the injection molded parts are extremely diversified products. The existing ways to achieve diversity of the injection molded parts comprise shapes and patterns, among which the diversity of patterns can be achieved by the following methods: 1. patterns are carved and sprayed on the surface of the injection molded part, 2. a double-color disc injection molding machine disclosed by Chinese patent No. CN202120098481.X is used to produce a double-color flying disc, and 3. injection fluids of various colors are mixed to perform injection molding through the above injection mold, etc.

The above-mentioned production molds and production processes for the diversified injection molded parts have been relatively mature. Therefore, whether there are other production methods for injection molded parts that can further improve diversity to meet the market has become an urgent research and development direction.

### SUMMARY

In view of the deficiencies of the prior art, it is a purpose of the present invention to provide a rotary injection mold capable of producing an injection molded part with a swirl pattern.

In order to achieve the above purpose, the present invention provides the following technical solutions: a rotary injection mold for producing a swirl injection molded part which is used for producing an injection molded part with a swirl pattern, comprises: a first mold; a second mold, wherein the first mold and the second mold are capable of being clamped to and separated from each other; a first mold core rotatably mounted in the first mold; a second mold core rotatably mounted in the second mold, wherein the first mold and the second mold are clamped such that the first mold core and the second mold core fit together to form an injection molding cavity; and a driving mechanism coupled to the first mold core and/or the second mold core to drive the first mold core and the second mold core to rotate synchronously; and an injection molding hole is provided on the first mold core and/or the second mold core for injecting an injection molding liquid into the injection molding cavity, and an axis of the injection molding hole, a rotation axis of the first mold core and a rotation axis of the second mold core are arranged collinear.

The present invention is further arranged such that the injection molding hole is arranged on the first mold core, the driving mechanism comprises a power output member, and the power output member is rotatably mounted on the second mold and fixedly connected with the second mold core to drive the second mold core to rotate.

The present invention is further arranged such that the driving mechanism comprises a driving motor and a multistage gear set, the driving motor is fixedly arranged on an outer periphery of the second mold, the power output member is arranged inside the second mold, the multistage gear set is used for coupling an output shaft of the driving motor with the power output member such that the driving motor drives the power output member to rotate, and a built-in cavity for mounting the multistage gear set is provided inside the second mold.

The present invention is further arranged such that the first mold comprises a first mold base and a second mold base which are detachable from each other, the first mold base is located on an outer periphery of the first mold core, the second mold base is located on a side of the first mold core away from the second mold core, a first axial positioning portion is provided on the first mold core, and the first axial positioning portion is clamped by the first mold base and the second mold base to be axially positioned and mounted; the second mold comprises a third mold base and a fourth mold base which are detachable from each other, the third mold base is located on an outer periphery of the second mold core, the fourth mold base is located on a side of the second mold core away from the first mold core, a second axial positioning portion is provided on the second mold core, and the second axial positioning portion is clamped by the third mold base and the fourth mold base to be axially positioned and mounted; and the power output member is arranged on the fourth mold base, and the power output member is detachably connected with the second mold core.

The present invention is further arranged such that a first bearing is provided between an inner periphery of the first mold base and the outer periphery of the first mold core to enable the first mold core to be rotatably mounted on the first mold base, a third axial positioning portion is provided on the first mold base, and the first axial positioning portion and the third axial positioning portion are respectively located on both axial sides of the first bearing so as to perform axial positioning of the first mold base, the first bearing and the first mold core; a second bearing is provided between the second mold base and the first mold core to support an acting force of the first mold core towards the direction of the second mold base, a third bearing is provided between an inner periphery of the third mold base and the outer periphery of the second mold core to enable the second mold core to be rotatably mounted on the third mold base, a fourth axial positioning portion is provided on the third mold base, and the second axial positioning portion and the fourth axial positioning portion are respectively located on both axial sides of the third bearing to perform axial positioning of the third mold base, the third bearing and the second mold core; and a fourth bearing is provided between the fourth mold base and the second mold core to support an acting force of the second mold core towards the direction of the fourth mold base.

The present invention is further arranged such that an injection molding pipe is provided on the first mold and/or the second mold and is detachably mounted, the injection molding pipe is inserted into the injection molding hole, and an outer periphery of the injection molding pipe has a shape and size adapted to a shape and size of a peripheral wall of the injection molding hole.

The present invention is further arranged such that a synchronous connector is provided between the first mold core and the second mold core, the synchronous connector comprises a synchronous insertion rod, a mounting insertion hole and a synchronous insertion hole, the mounting insertion hole is arranged in the first mold core or the second mold core in a penetrating manner, the synchronous insertion rod is arranged in the mounting insertion hole, the synchronous insertion hole is arranged in the second mold core or the first mold core for inserting the synchronous insertion rod, the synchronous insertion rod is provided with a clamping protrusion at one end away from the synchronous insertion hole, and the clamping protrusion is clamped between the first mold core and the second mold base to be axially positioned and mounted.

The present invention is further arranged such that one axial side of the power output member toward the second mold core is provided with a connecting insertion block, the second mold core is provided with a connecting slot, the power output member is provided with a connecting perforation in a penetrating manner along a rotation axis, the second mold core is correspondingly provided with a connecting screw hole, and a connecting bolt is provided between the power output member and the second mold core; the connecting insertion block is inserted into the connecting slot to enable the power output member and the second mold core to be circumferentially linked; and the connecting bolt passes through the connecting perforation and is in thread fit with the connecting screw hole to axially limit the power output member and the second mold core.

A production process for producing a swirl injection molded part, using the rotary injection mold described above to produce an injection molded part with a swirl pattern, comprises the following steps:
S1, clamping the first mold and the second mold;
S2, starting the driving mechanism to synchronously drive the first mold core and the second mold core to rotate;
S3, injecting injection molding liquids of at least two colors into the injection molding cavity through the injection molding hole successively;
S4, turning off the driving mechanism after injection molding so as to stop motion of the first mold core and the second mold core, and waiting for the injection molding liquids in the injection molding cavity to cool into the injection molded part; and
S5, separating the first mold from the second mold, and demolding the injection molded part from the injection molding cavity.

### BRIEF DESCRIPTION OF THE DRAWINGS

In order to illustrate the technical solutions of the embodiments of the present invention or the prior art more clearly, the accompanying drawings required for the description of the embodiments or the prior art will be briefly introduced below. Apparently, the accompanying drawings in the following description are merely some rather than all embodiments of the present invention, and a person of ordinary skill in the art may still derive other drawings from these accompanying drawings without creative efforts.

FIG. 1 is an assembly view of a rotary injection mold for producing a swirl injection molded part according to Embodiment 1 of the present invention;

FIG. 2 is an exploded view of the rotary injection mold for producing a swirl injection molded part according to Embodiment 1 of the present invention;

FIG. 3 is a sectional view of the rotary injection mold for producing a swirl injection molded part according to Embodiment 1 of the present invention;

FIG. 4 is an exploded view of a first mold according to Embodiment 1 of the present invention;

FIG. 5 is an exploded view of a second mold according to Embodiment 1 of the present invention;

FIG. 6 is an enlarged view of A in FIG. 3;

FIG. 7 is an enlarged view of B in FIG. 3;

FIG. 8 is an enlarged view of C in FIG. 5;

FIG. 9 is an enlarged view of D in FIG. 3;

FIG. 10 is a sectional view of the rotary injection mold for producing a swirl injection molded part according to Embodiment 1 of the present invention;

FIG. 11 is an enlarged view of E in FIG. 10;

FIG. 12 is an assembly view of a rotary injection mold for producing a swirl injection molded part according to Embodiment 8 of the present invention;

FIG. 13 is an assembly view of a rotary injection mold for producing a swirl injection molded part according to Embodiment 9 of the present invention; and

FIG. 14 is a product diagram of an injection molded part according to Embodiment 1 of the present invention.

Reference numerals: 1. first mold; 11. first mold base; 12. second mold base; 111. third axial positioning portion; 2. second mold; 21. third mold base; 22. fourth mold base; 23. built-in cavity; 24. connecting rod; 211. fourth axial positioning portion; 3. first mold core; 31. first axial positioning portion; 4. second mold core; 41. second axial positioning portion; 42. connecting slot; 43. connecting screw hole; 5. driving mechanism; 51. power output member; 52. driving motor; 53. connecting shaft; 54. multistage gear set; 55. base body; 56. external teeth; 511. connecting insertion block; 512. connecting perforation; 61. first bearing; 62. second bearing; 63. third bearing; 64. fourth bearing; 7. synchronous connector; 71. synchronous insertion rod; 72. mounting insertion hole; 73. synchronous insertion hole; 711. clamping protrusion; 81. bushing; 82. Shaft lever; 83. clearance; 91. injection molding cavity; 92. injection molding hole; 93. injection molding pipe; 94. connecting bolt; 99. injection molded part; and 991. swirl.

### DESCRIPTION OF THE EMBODIMENTS

In order to make those skilled in the art better understand the present invention and thereby define the scope of the present invention more clearly, the present invention is described below in detail with respect to some specific embodiments of the present invention. It should be noted that the following description only relates to some specific embodiments of the inventive concept and are only part of the embodiments of the present invention, specific and direct descriptions of relevant structures are merely for the convenience of understanding the present invention, and the specific features do not, of course, directly limit the implementation scope of the present invention. Conventional choices and alternatives made by those skilled in the art under the guidance of the inventive concept should be considered within the scope of the present invention.

### Embodiment 1

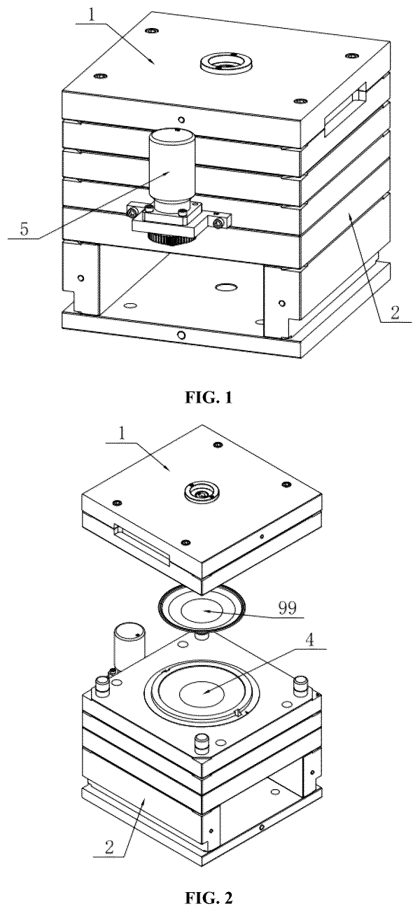

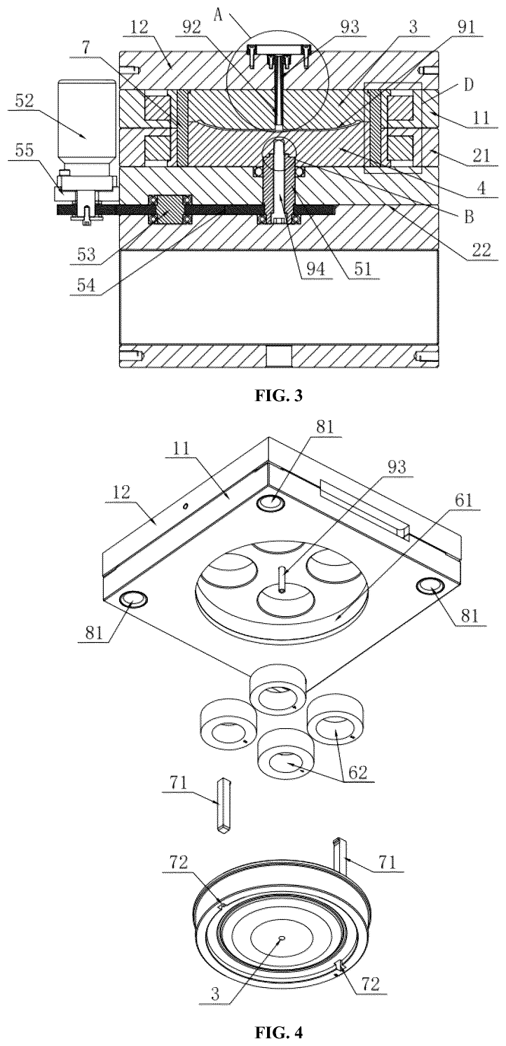

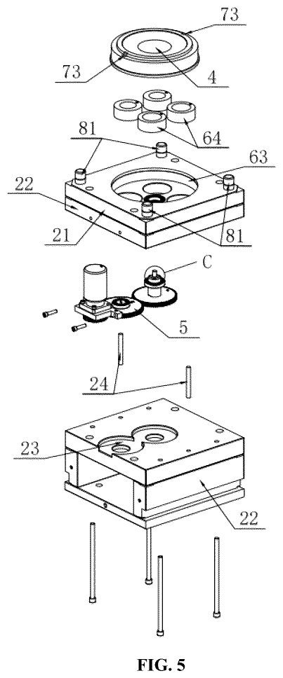

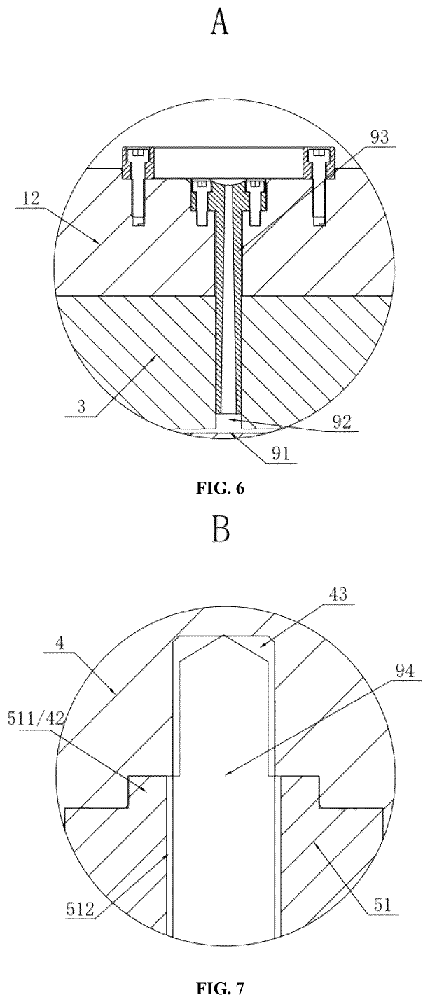

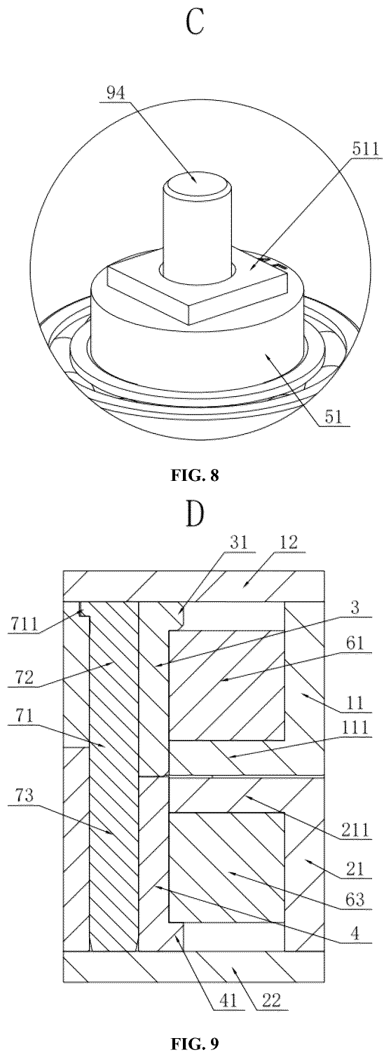

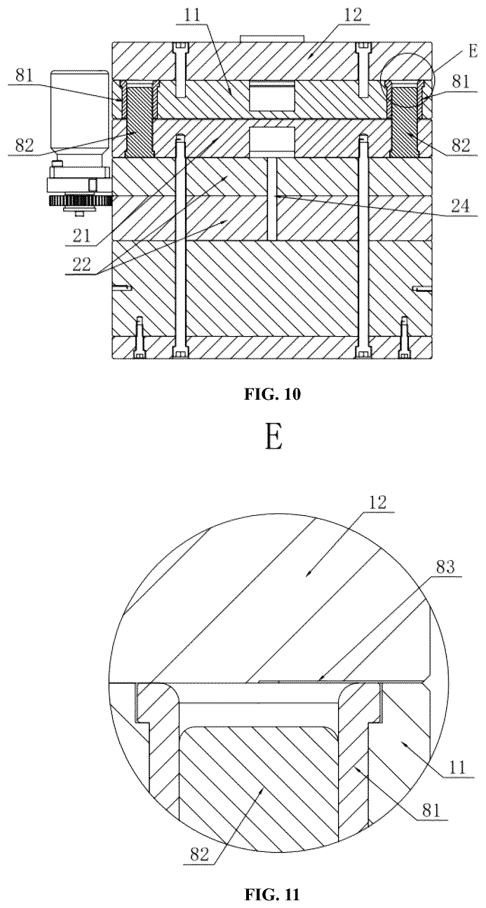

As shown in FIGS. 1-11, the present invention discloses a rotary injection mold for producing a swirl injection molded part, comprising: a first mold 1 and a second mold 2 located on a lower side of the first mold 1, wherein the first mold 1 and the second mold 2 can be clamped to and separated from each other; a first mold core 3 built in the lower side of the first mold 1 and rotatably mounted on the first mold 1, and a second mold core 4 built in an upper side of the second mold 2 and rotatably mounted on the second mold 2; wherein the first mold 1 and the second mold 2 are clamped such that the first mold core 3 and the second mold core 4 fit together to form an injection molding cavity 91, a shape of the injection molding cavity 91 is the same as the injection molding part 99 to be produced, and demolding can be performed in an top-down direction; and a driving mechanism 5 coupled to the first mold core 3 and/or the second mold core 4 to drive the first mold core 3 and the second mold core 4 to rotate synchronously; and furthermore, an injection molding hole 92 is provided on the first mold core 3 and/or the second mold core 4 for injecting an injection molding liquid into the injection molding cavity 91, and an axis of the injection molding hole 92, a rotation axis of the first mold core 3 and a rotation axis of the second mold core 4 are arranged collinear.

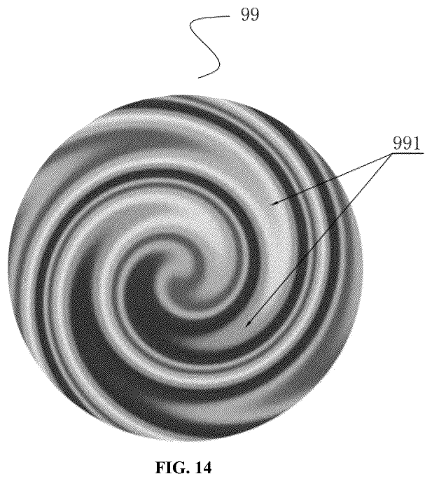

Therefore, in the case where the first mold core 3 and the second mold core 4 rotate, injection molding liquids of different colors can be successively injected from the injection molding hole 92 (fixed-point injection molding) into the injection molding cavity 91 one by one, such that as shown in FIG. 14, the injection molding liquids diffuse in a swirl 991 path under centrifugal action to form a swirl 991 pattern, and since the injection molding liquids are of multiple colors (at least two colors), different colors will present their respective swirl 991 patterns so as to present different color patterns, the injection molded part 99 produced by the rotary injection mold is different from current commercially available injection molded parts 99, the swirl 991 pattern therein is the pattern of the injection molded part 99 itself, and there is no need to add a subsequent pattern, so it is not easy to be damaged, and the swirl 991 pattern is distributed on upper and lower surfaces of the injection molded part 99, producing better integrity.

Specifically, the shape of the injection molded part 99 in the present embodiment is the shape of a flying disc which rotates at a high speed when used to create a more dazzling flight from top to bottom, and can also be the shape of any injection moldable product such as a cup, a box, etc.

More specifically, the swirl 991 pattern is a V-shaped (dovetail-shaped) swirl 991 which is presented due to separation of the injection molding liquids of different colors injected first and injection molding liquids of different colors injected later, and is colorful.

Preferably, the injection molding cavity 91 is disc-shaped, and an axis of the injection molding cavity 91 is arranged colinear with the rotation axis of the first mold core 3 such that the injection molded injection part 99 takes the axis as the center to present the swirl 991 pattern.

In addition, the injection molded part 99 can also be a square disc or other irregular disc, and the injection molding hole 92 can correspond to any position of the injection molding cavity 91 such that centrifugal rotation can produce different patterns, but the patterns all have swirls 991.

Specifically, in the present embodiment, the injection molding hole 92 is arranged on the first mold core 3, and the driving mechanism 5 comprises a power output member 51, and the power output member 51 is rotatably mounted on the second mold 2 in a bearing manner, and is fixedly connected with the second mold core 4 to drive the second mold core 4 to rotate.

In addition, in the present embodiment, the driving mechanism 5 comprises a driving motor 52, a connecting shaft 53 and a multistage gear set 54; the driving motor 52 is fixed to an outer periphery of the second mold 2 using a detachable base body 55, the connecting shaft 53 is rotatably mounted in the second mold 2 in a bearing manner, and the power output member 51 is arranged in the second mold 2; the multistage gear set 54 comprises a first gear fixed to an output shaft of the driving motor 52, a second gear fixed to the connecting shaft 53 and a third gear fixed to the power output member 51, and the three gears are successively meshed to couple the output shaft of the driving motor 52 with the power output member 51 such that the driving motor 52 drives the power output member 51 to rotate.

In addition, a built-in cavity 23 is provided in the second mold 2 for mounting the multistage gear set 54 and the connecting shaft 53, such that built-in mounting is less disturbed by the external connection.

Specifically, in the present embodiment, the first mold 1 comprises a first mold base 11 and a second mold base 12 located above the first mold base 11 which are superposed, are fixedly mounted using vertical bolts, and separated from each other by a detachable bolt; the first mold base 11 is located on an outer periphery of the first mold core 3, and the second mold base 12 is located on an upper side of the first mold core 3; in addition, the outer periphery of the first mold core 3 is provided with an annular first axial positioning portion 31, such that the first axial positioning portion 31 is clamped by the first mold base 11 and the second mold base 12 from top to bottom to be axially positioned and mounted; similarly, the second mold 2 comprises a third mold base 21 and a fourth mold base 22 which are detachable from each other, the third mold base 21 is located on an outer periphery of the second mold core 4, the fourth mold base 22 is located at a lower side of the second mold core 4, a second axial positioning portion 41 is provided on the second mold core 4, and the second axial positioning portion 41 is clamped by the third mold base 21 and the fourth mold base 22 to be axially positioned and mounted; in addition, the power output member 51 is arranged on the fourth mold base 22, and the power output member 51 is detachably connected with the second mold core 4.

Therefore, if different types of injection molded parts 99 need to be produced, only the first mold core 3 and the second mold core 4 need to be replaced, and there is no need to replace the whole mold, resulting in decreased cost of the mold. Specifically, after the first mold 1 and the second mold 2 are separated, the first mold base 11 and the second mold base 12 are separated through bolt removal, and then the first mold core 3 is removed from the first mold base 11 in an upward direction, such that the first mold core 3 can be replaced or repaired, and the second mold core 4 can be replaced or repaired in the same manner.

Preferably, in order to facilitate disassembly and assembly of the multistage gear set 54 and the connecting shaft 53, the fourth mold base 22 is arranged in a multi-mold base and is detachably connected with a bolt; and preferably, a plurality of connecting rods 24 are additionally provided between a mold base corresponding to the built-in cavity 23 and a closed mold base, such that two corresponding mold bases are respectively inserted through the connecting rods 24 to make the correspondence more accurate, thus resulting in more accurate alignment fit of the driving mechanism 5 and more stable driving.

Furthermore, in the present embodiment, a first bearing 61 (radial bearing) is provided between an inner periphery of the first mold base 11 and the outer periphery of the first mold core 3 to enable the first mold core 3 to be rotatably mounted on the first mold base 11; in addition, a third axial positioning portion 111 is provided on the first mold base 11, and the first axial positioning portion 31 and the third axial positioning portion 111 are respectively located on both axial sides of the first bearing 61, such that the third axial positioning portion 111, the first bearing 61 and the first axial positioning portion 31 successively abut against each other to perform axial positioning of the first mold base 11, the first bearing 61 and the first mold core 3; in addition, a second bearing 62 (thrust bearing) is provided between the second mold base 12 and the first mold core 3 to support an acting force of the first mold core 3 towards the direction of the second mold base 12; similarly, a third bearing 63 is provided between an inner periphery of the third mold base 21 and the outer periphery of the second mold core 4 to enable the second mold core 4 to be rotatably mounted on the third mold base 21; a fourth axial positioning portion 211 is provided on the third mold base 21, and the second axial positioning portion 41 and the fourth axial positioning portion 211 are respectively located on both axial sides of the third bearing 63 to perform axial positioning of the third mold base 21, the third bearing 63 and the second mold core 4, and a fourth bearing 64 is provided between the fourth mold base 22 and the second mold core 4 to support an acting force of the second mold core 4 towards the direction of the fourth mold base 22.

Therefore, 1. the first bearing 61 and the third bearing 63 enable smoother rotation of the first mold core 3 and the second mold core 4, while the second bearing 62 and the fourth bearing 64 axially support the first mold core 3 and the second mold core 4 when the first mold 1 and the second mold 2 are clamped and pressed so as to prevent the first mold core 3 and the second mold core 4 from pressing against the corresponding first mold 1 and the second mold 2, resulting in too great friction to rotate; and 2. the third axial positioning portion 111, the first bearing 61, the first axial positioning portion 31 (the first mold core 3), the second bearing 62 and the second mold base 12 are positioned in the axial direction and then axially locked with bolts, resulting on matched overall axial height and accurate mounting and absence of excessive clearance 83 which results in noise in the use of the mold; and similarly, the fourth axial positioning part 211, the third bearing 63, the second axial positioning part 41 (the second mold core 4), the fourth bearing 64 and the fourth mold base 22 are positioned in the axial direction and then axially locked with bolts, resulting in highly matched overall axial height, accurate mounting and absence of excessive clearance 83 which results in noise in the use of the mold.

Specifically, in the present embodiment, four second bearings 62 and four fourth bearings 64 are circumferentially arranged at intervals so as to be axially supported at multiple positions to improve axial supporting uniformity and stability.

Furthermore, in the present embodiment, an injection molding pipe 93 is provided on the second mold base 12 and is detachably mounted, the injection molding pipe 93 is inserted into the injection molding hole 92, and an outer periphery of the injection molding pipe 93 has a shape and size adapted to a shape and size of a peripheral wall of the injection molding hole 92. Therefore, 1. the injection molding pipe 93 extends into the injection molding hole 92 to achieve a smaller contact area between the injection molding liquid and an inner peripheral wall of the injection molding hole 92, and enters the injection molding cavity 91 faster after leaving the injection molding pipe 93 (stationary), thereby reducing the impact of the rotating injection molding hole 92 causing the injection molded part 99 to break when the injection molding liquid cools, enabling smoothing processing, and 2, the detachable injection molding pipe 93 can be correspondingly replaced together with the first mold core 3 and the second mold core 4 that need to be replaced for the production of different injection molded parts 99, resulting in better adaptability.

Specifically, the second mold base 12 is perforated vertically such that the injection molding pipe 93 is inserted from top to bottom and further inserted into the injection molding hole 92 through the perforation, and the injection molding pipe 93 is mounted above the second mold base 12 by means of a bolt.

In addition, in the present embodiment, a synchronous connector 7 is provided between the first mold core 3 and the second mold core 4, the synchronous connector 7 comprises a synchronous insertion rod 71, a mounting insertion hole 72 and a synchronous insertion hole 73. Specifically, the mounting insertion hole 72 is vertically arranged in the first mold core 3 in a penetrating manner, the synchronous insertion rod 71 is arranged in the mounting insertion hole 72, and the synchronous insertion hole 73 is arranged in the second mold core 4 for inserting the synchronous insertion rod 71. Therefore, when the first mold 1 and the second mold 2 are clamped, the synchronous insertion rod 71 will be inserted into the synchronous insertion hole 73 so as to align the injection molding cavity 91 from top to bottom. In addition, subsequently, the first mold core 3 and the second mold core 4 have the function of circumferential synchronous limiting in the rotation process, which prevents the first mold core 3 and the second mold core 4 from slipping and causing leakage of the injection molding liquid and damage of the injection molded part 99, etc.

Preferably, in the present embodiment, the synchronous insertion rod 71 is provided with a clamping protrusion 711 at the end away from the synchronous insertion hole 73, the clamping protrusion 711 is clamped between the first mold core 3 and the second mold base 12 so as to be axially positioned and mounted, such that after the first mold 1 is mounted, the clamping protrusion 711 is clamped and mounted more stably. Furthermore, during the disassembly process, after the second mold base 12 is disassembled, an upper end of the synchronous insertion rod 71 is exposed, such that the synchronous insertion rod 71 can be pushed upwards by pushing the synchronous insertion rod 71 upwards at a lower end of the synchronous insertion rod 71, which results in more convenient disassembly.

Preferably, several synchronous connectors 7 are provided (two connectors are used in the present embodiment) and are circumferentially arranged at intervals so as to increase insertion strength and improve connection stability.

In addition, in the present embodiment, an upper end of the power output member 51 is provided with a connecting insertion block 511, the second mold core 4 is provided with a connecting slot 42, and the power output member 51 and the second mold core 4 are circumferentially linked by inserting the connecting insertion block 511 into the connecting slot 42, such that the power output member 51 rotates to drive the second mold core 4 to rotate so as to synchronously drive the first mold core 3 to rotate.

Specifically, the connecting insertion block 511 and the connecting insert groove 42 may be arranged in the shape of a polygonal prism (quadrangular prism in the present embodiment), polygonal shape, oval shape, etc. or arranged eccentrically.

Furthermore, in the present embodiment, the power output member 51 is provided with a connecting perforation 512 in a penetrating manner along a rotation axis, the second mold core 4 is correspondingly provided with a connecting screw hole 43, and a connecting bolt 94 is provided between the power output member 51 and the second mold core 4; the connecting bolt 94 passes through the connecting perforation 512 and is in thread fit with the connecting screw hole 43 to axially limit the power output member 51 and the second mold core 4, and therefore, with provision of the connecting bolt 94, the power output member 51 and the second mold core 4 are connected with a high strength in an axial limiting manner, so as to prevent disordered movement caused by being out of fit between the connecting insertion block 511 and the connecting slot 42 due to axial play.

Preferably, an axis of the connecting bore 512 is the same as a rotation axis of the power output member 51, such that the connecting bolt 94 does not provide torque support and is only used for an axial fixed connection, preventing failure of the axial connection due to breakage of the connecting bolt 94.

Furthermore, in the present embodiment, four corner ends of the first mold 1 are provided with bushings 81, and correspondingly, four corner ends of the first mold 1 are provided with shaft levers 82, such that when the first mold 1 and the second mold 2 are clamped, the bushings 81 is in fit with the shaft levers 82 to align and clamp the molds.

Preferably, in the present embodiment, the bushing 81 is provided in the first mold base 11, and an upper end thereof is covered by the second mold base 12; in addition, a clearance 83 is respectively provided between the first mold base 11 and the second the second mold base 12 corresponding to the respective bushings 81, and the clearance 83 is communicated with the corresponding bushing 81, such that when the bushing 81 and the shaft lever 82 are in fit through insertion, a pressure in the bushing 81 at an upper end of the shaft lever 82 is balanced, such that the first mold base 11 and the second mold base 12 can be smoothly clamped.

Based on the rotary injection mold for producing a swirl injection molded part disclosed in the present embodiment, the present embodiment also discloses a production process for producing a swirl injection molded part which specifically comprises the following steps:

In the preliminary work, an injection molding source is connected to an upper end of the injection molding pipe 93, injection molding liquids provided by the injection molding source are injection molding liquids of at least two unstirred colors, and the rotary injection mold is mounted on a hydraulic press; then
S1, clamping the first mold 1 and the second mold 2;
S2, starting the driving mechanism 5 to synchronously drive the first mold core 3 and the second mold core 4 to rotate;
S3, injecting the injection molding liquids provided by the injection molding source into the injection molding cavity 91 through the injection molding hole 92;
S4, turning off the driving mechanism 5 after injection molding so as to stop motion of the first mold core 3 and the second mold core 4, and waiting for the injection molding liquids in the injection molding cavity 91 to cool into the injection molded part; and
S5, separating the first mold 1 from the second mold 2, and demolding the injection molded part from the injection molding cavity 91.

In addition, the present embodiment also discloses a production process for producing swirl injection molded parts, which specifically comprises the following steps: in the preliminary work, the injection molding source is connected to the upper end of the injection molding pipe 93, the injection molding source is composed of several single-color feed cylinders and converges in the same material pipe, and the rotary injection mold is mounted on the hydraulic press; then
S1, clamping the first mold 1 and the second mold 2;
S2, starting the driving mechanism 5 to synchronously drive the first mold core 3 and the second mold core 4 to rotate;
S3, injecting injection molding liquids provided by different feed cylinders sequentially and timely into the injection molding cavity 91 through the injection molding hole 92;
S4, turning off the driving mechanism 5 after injection molding so as to stop motion of the first mold core 3 and the second mold core 4, and waiting for the injection molding liquids in the injection molding cavity 91 to cool into the injection molded part; and
S5, separating the first mold 1 from the second mold 2, and demolding the injection molded part from the injection molding cavity 91.

As a result, the injection molding liquids will diffuse in the form of a swirl 991 under the centrifugal action and produce an injection molded part 99 as shown in FIG. 14, wherein the injection molded part 99 produced by the first production process has random color arrangement and is liable to have assorted colors (due to color mixing), while the injection molded part 99 produced by the second production process is controllable in color and has a more uniform transition between two colors.

In addition, it is also possible to use the above-mentioned rotary injection mold to inject the injection molding liquid of a single color, and although the injection molding liquids of the same color are mixed with each other, the centrifugal force generated by the rotation will cause the surface of the injection molded part 99 to form a visible swirl 991 pattern. Therefore, using the rotary injection mold to produce the injection molded part 99 of a single color does not depart from the scope of protection of this patent.

### Embodiment 2

A rotary injection mold for producing a swirl injection molded part, has a main structure same as that of Embodiment 1 except that the first mold 1 and the second mold 2 are arranged side by side to perform mold clamping and separation in the left and right direction.

### Embodiment 3

A rotary injection mold for producing a swirl injection molded part, has a main structure same as that of Embodiment 1 except that the driving mechanism 5 does not comprise the driving motor 52 and the multistage gear set 54. The following two solutions can be used.

In the first solution, a slot or a protruding column is made on the power output member 51, and a motor is driven to connect with the slot or the protruding column as an external driving source, such that the linked power output member 51 drives the first mold core 3 and the second mold core 4 to rotate.

In the second solution, gears are provided on an outer periphery of the power output member 51, and the motor and other linked gears are driven as an external driving source to achieve gear meshing, such that the linked power output member 51 drives the first mold core 3 and the second mold core 4 to rotate.

### Embodiment 4

A rotary injection mold for producing a swirl injection molded part, has a main structure same as that of Embodiment 1 except that the driving mechanism 5 does not comprise the multistage gear set 54 but uses the fit between a chain and a sprocket or the fit between a belt and a pulley.

It is also possible to use a cylinder, a rack and gears as equivalent substitutions without arrangement of the driving motor 52.

### Embodiment 5

A rotary injection mold for producing a swirl injection molded part, has a main structure same as that of Embodiment 1 except that there is only one second bearing 62 and only one fourth bearing 64, an axis of the second bearing 62 is collinear with the rotation axis of the first mold core 3, and an axis of the fourth bearing 64 is collinear with the rotation axis of the second mold core 4, so as to support the thrust bearing.

### Embodiment 6

A rotary injection mold for producing a swirl injection molded part, has a main structure same as that of Embodiment 1 except that the mounting insertion hole 72 is vertically arranged in the second mold core 4 in a penetrating manner, and the synchronization insertion hole 73 is arranged in the first mold core 3.

### Embodiment 7

A rotary injection mold for producing a swirl injection molded part, has a main structure same as that of Embodiment 1 except that the power output member 51 and the second mold core 4 are fixedly connected directly by means of a plurality of circumferentially arranged bolts or a radial insertion rod.

### Embodiment 8

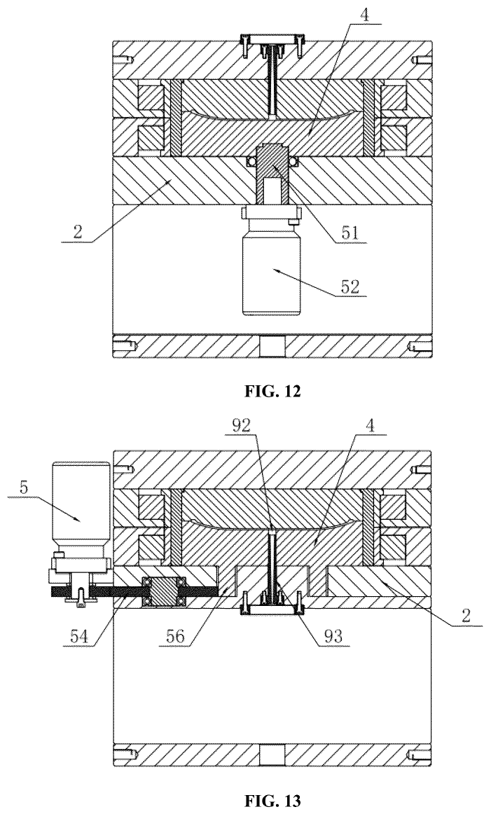

As shown in FIG. 12, a rotary injection mold for producing a swirl injection molded part, has A main structure same as Embodiment 1 except that the driving mechanism 5 does not comprise the multistage gear set 54, the driving motor 52 is directly arranged on a lower side of the power output member 51, and the output shaft of the driving motor 52 is directly connected to a lower end of the power output member 51 by means of a key connection or the like for driving.

### Embodiment 9

As shown in FIG. 13, a rotary injection mold for producing a swirl injection molded part, has a main structure same as Embodiment 1 except that the driving mechanism 5 does not comprise the power output member 51, external teeth 56 are integrally formed at the lower end of the second mold core 4 or an external tooth 56 gear is fixedly mounted so as to realize driving by the multistage gear set 54 in a meshing manner.

In addition, an inner periphery of the outer teeth 56 or an inner periphery of the outer tooth 56 gear is hollow, such that the injection molding hole 92 can be arranged on the second mold core 4, and correspondingly, the injection molding pipe 93 can be arranged in the second mold 2 (the fourth mold base 22).

Depending on the requirements, the injection molding holes 92 can be arranged on the first mold core 3, such that both the first mold core 3 and the second mold core 4 can be available for injection molding.

The previous description of the disclosed embodiments is provided to enable any person skilled in the art to make or use the present invention. Various modifications to these embodiments will be readily apparent to those skilled in the art, and the generic principles defined herein may be implemented in other embodiments without departing from the spirit or scope of the present invention. Thus, the present invention is not intended to be limited to the embodiments shown herein but is to be accorded the widest scope consistent with the principles and novel features disclosed herein.

What is claimed is:

1. A rotary injection mold for producing a swirl injection molded part, for producing an injection molded part with a swirl pattern, comprising:
a first mold;
a second mold, the first mold and the second mold being capable of being clamped to and separated from each other;
a first mold core rotatably mounted in the first mold;
a second mold core rotatably mounted in the second mold, the first mold and the second mold being clamped such that the first mold core and the second mold core fit together to form an injection molding cavity; and
a driving mechanism coupled to the first mold core and/or the second mold core to drive the first mold core and the second mold core to rotate synchronously; and
an injection molding hole is provided on the first mold core and/or the second mold core for injecting an injection molding liquid into the injection molding cavity, and an axis of the injection molding hole, a rotation axis of the first mold core and a rotation axis of the second mold core are arranged collinear.

2. The rotary injection mold for producing a swirl injection molded part according to claim 1, wherein the injection molding hole is arranged on the first mold core, the driving mechanism comprises a power output member, and the power output member is rotatably mounted on the second mold and fixedly connected with the second mold core to drive the second mold core to rotate.

3. The rotary injection mold for producing a swirl injection molded part according to claim 2, wherein the driving mechanism comprises a driving motor and a multistage gear set, the driving motor is fixedly arranged on an outer periphery of the second mold, the power output member is arranged inside the second mold, the multistage gear set is used for coupling an output shaft of the driving motor with the power output member such that the driving motor drives the power output member to rotate, and a built-in cavity for mounting the multistage gear set is provided inside the second mold.

4. The rotary injection mold for producing a swirl injection molded part according to claim 2, wherein the first mold comprises a first mold base and a second mold base which are detachable from each other, the first mold base is located on an outer periphery of the first mold core, the second mold base is located on a side of the first mold core away from the second mold core, a first axial positioning portion is provided on the first mold core, and the first axial positioning portion is clamped by the first mold base and the second mold base to be axially positioned and mounted;
the second mold comprises a third mold base and a fourth mold base which are detachable from each other, the third mold base is located on an outer periphery of the second mold core, the fourth mold base is located on a side of the second mold core away from the first mold core, a second axial positioning portion is provided on the second mold core, and the second axial positioning portion is clamped by the third mold base and the fourth mold base to be axially positioned and mounted; and
the power output member is arranged on the fourth mold base, and the power output member is detachably connected with the second mold core.

5. The rotary injection mold for producing a swirl injection molded part according to claim 4, wherein a first bearing is provided between an inner periphery of the first mold base and the outer periphery of the first mold core to enable the first mold core to be rotatably mounted on the first mold base, a third axial positioning portion is provided on the first mold base, and the first axial positioning portion and the third axial positioning portion are respectively located on both axial sides of the first bearing so as to perform axial positioning of the first mold base, the first bearing and the first mold core; a second bearing is provided between the second mold base and the first mold core to support an acting force of the first mold core towards the direction of the second mold base, a third bearing is provided between an inner periphery of the third mold base and the outer periphery of the second mold core to enable the second mold core to be rotatably mounted on the third mold base, a fourth axial positioning portion is provided on the third mold base, and the second axial positioning portion and the fourth axial positioning portion are respectively located on both axial sides of the third bearing to perform axial positioning of the third mold base, the third bearing and the second mold core; and a fourth bearing is provided between the fourth mold base and the second mold core to support an acting force of the second mold core towards the direction of the fourth mold base.

6. The rotary injection mold for producing a swirl injection molded part according to claim 1, wherein an injection molding pipe is provided on the first mold and/or the second mold and is detachably mounted, the injection molding pipe is inserted into the injection molding hole, and an outer periphery of the injection molding pipe has a shape and size adapted to a shape and size of a peripheral wall of the injection molding hole.

7. The rotary injection mold for producing a swirl injection molded part according to claim 1, wherein a synchronous connector is provided between the first mold core and the second mold core, the synchronous connector comprises a synchronous insertion rod, a mounting insertion hole and a synchronous insertion hole, the mounting insertion hole is arranged in the first mold core or the second mold core in a penetrating manner, the synchronous insertion rod is arranged in the mounting insertion hole, the synchronous insertion hole is arranged in the second mold core or the first mold core for inserting the synchronous insertion rod, the synchronous insertion rod is provided with a clamping protrusion at one end away from the synchronous insertion hole, and the clamping protrusion is clamped between the first mold core and the second mold base to be axially positioned and mounted.

8. The rotary injection mold for producing a swirl injection molded part according to claim 2, wherein one axial side of the power output member toward the second mold core is provided with a connecting insertion block, the second mold core is provided with a connecting slot, the power output member is provided with a connecting perforation in a penetrating manner along a rotation axis, the second mold core is correspondingly provided with a connecting screw hole, and a connecting bolt is provided between the power output member and the second mold core;
the connecting insertion block is inserted into the connecting slot to enable the power output member and the second mold core to be circumferentially linked; and
the connecting bolt passes through the connecting perforation and is in thread fit with the connecting screw hole to axially limit the power output member and the second mold core.

9. A production process for producing a swirl injection molded part, using the rotary injection mold according to claim 1 to produce an injection molded part with a swirl pattern, comprising the following steps:
S1, clamping the first mold and the second mold;
S2, starting the driving mechanism to synchronously drive the first mold core and the second mold core to rotate;
S3, injecting injection molding liquids of at least two colors into the injection molding cavity through the injection molding hole successively;
S4, turning off the driving mechanism after injection molding so as to stop motion of the first mold core and the second mold core, and waiting for the injection molding liquids in the injection molding cavity to cool into the injection molded part; and
S5, separating the first mold from the second mold, and demolding the injection molded part from the injection molding cavity.
